(19) United States
(12) Patent Application Publication
(10) Pub. No.: US 2018/0215020 A1
(43) Pub. Date: Aug. 2, 2018

(54) QUICK RELEASE CONNECTOR

(71) Applicant: Unitek Enterprise Corp., BELIZE CITY (BZ)

(72) Inventor: Octav Dumitru, Surrey (CA)

(21) Appl. No.: 15/417,791

(22) Filed: Jan. 27, 2017

(51) Int. Cl. B25B 23/00; B23B 31/06

(52) U.S. Cl. CPC B25B 23/0035; B23B 31/06

(57) ABSTRACT

A quick release connector is provided, including: a main body, including a tubular section which defines an axial direction, the tubular section including an inner hole, an insertion opening communicating with the inner hole, a slanted groove communicating with the inner hole and a sliding groove axially extending and communicating with the inner hole, the slanted groove extending inwardly toward the insertion opening; an elastic abutting mechanism, abutted within the inner hole, for urging an insert member to insert into the inner hole via the insertion opening; a locking mechanism, including a pin portion and a locking portion, the pin portion disposed through the sliding groove and axially slidably movable together with the elastic abutting mechanism, the locking portion received in the slanted groove and radially projectable into the inner hole, the locking portion movable together with the pin portion and the elastic abutting mechanism.

### BACKGROUND OF THE INVENTION

### Field of the Invention

The present invention relates to a connector, and particularly to a quick release connector.

### Description of the Prior Art

As shown in FIG. 9, a conventional connector 200 for a tool bit 300 (such as screwdriver bit) includes a rod body 201, a jacket 202 and a connecting rod 203. The connecting rod and the rod body are assembled with each other, the connecting rod is for assembling with a driving device, and the rod body is for connection with a tool bit. The jacket is slidably assembled with the rod body and slidable between a locking position and a release position. Through the jacket pressing a blocking member to block into an engagement recess of the tool bit, the tool bit is lockably held. When the jacket moves, relative to the rod body, to the release position, the blocking member can move radially outward into a space of the jacket so as to release the engagement of the tool bit with the engagement recess, so that the tool bit can be detached. TW 1241231 and TW 1365128 disclose the kind of aforementioned tool.

However, in the conventional connector, the jacket has to be manufactured to include function of pressing the blocking member and provide release space for the blocking member. As a result, the inner wall of the jacket has must include a protrusive-recessed structure, so the structure is complicated, it is hard to process the inner wall of the jacket and it is not precise, so that the tool bit cannot be stably locked and is easy to disengage. Furthermore, during engagement/disengagement of the tool bit, it has to move the jacket by one hand of a user and insert/withdraw the tool bit by another hand of the user, and the release the jacket, and thus it cannot proceed with one single hand. Additionally, the jacket has a large diameter and is disposed at a front end of the rod body, so that it cannot be inserted and operated in a narrow hole, and the jacket can be damaged and moved to release the tool bit due to impact by the inner wall of the hole during rotating, which can do harm to user easily.

The present invention is, therefore, arisen to obviate or at least mitigate the above mentioned disadvantages.

### SUMMARY OF THE INVENTION

An object of the present invention is to provide a quick release connector, with which it is able to quickly replace an insert member, has a simple structure and is easy to use; furthermore, the user can replace the insert member by one single hand, and it is convenient, time-saving, and helpful to work.

To achieve the above and other objects, a quick release connector is provided, including: a main body, including a tubular section, the tubular section defining an axial direction, the tubular section including an inner hole, an insertion opening communicating with the inner hole, a slanted groove communicating with the inner hole and a sliding groove axially extending and communicating with the inner hole, the slanted groove extending inwardly toward the insertion opening; an elastic abutting mechanism, abutted within the inner hole, for urging an insert member being inserted into the inner hole via the insertion opening; a locking mechanism, including a pin portion and a locking portion, the pin portion disposed through the sliding groove and axially slidably movable together with the elastic abutting mechanism, the locking portion received in the slanted groove and radially projectable into the inner hole, the locking portion movable together with the pin portion and the elastic abutting mechanism.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a perspective view according to a preferred embodiment of the present invention;

FIG. 2 is a breakdown drawing of a preferred embodiment of the present invention;

FIG. 3 is a cross-sectional view of a preferred embodiment of the present invention;

FIGS. 4 and 5 are drawings showing a quick release connector in use according to a preferred embodiment of the present invention;

FIGS. 6 to 8 are drawings showing three applications of quick release connector according to different preferred embodiments of the present invention; and

FIG. 9 is a drawing of a conventional connector for a tool bit in use.

### DETAILED DESCRIPTION OF THE PREFERRED EMBODIMENTS

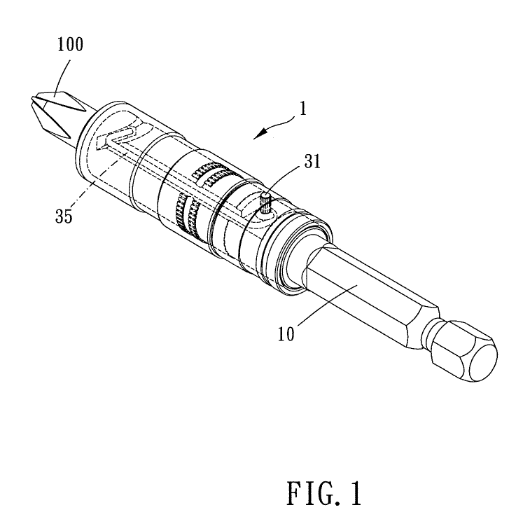

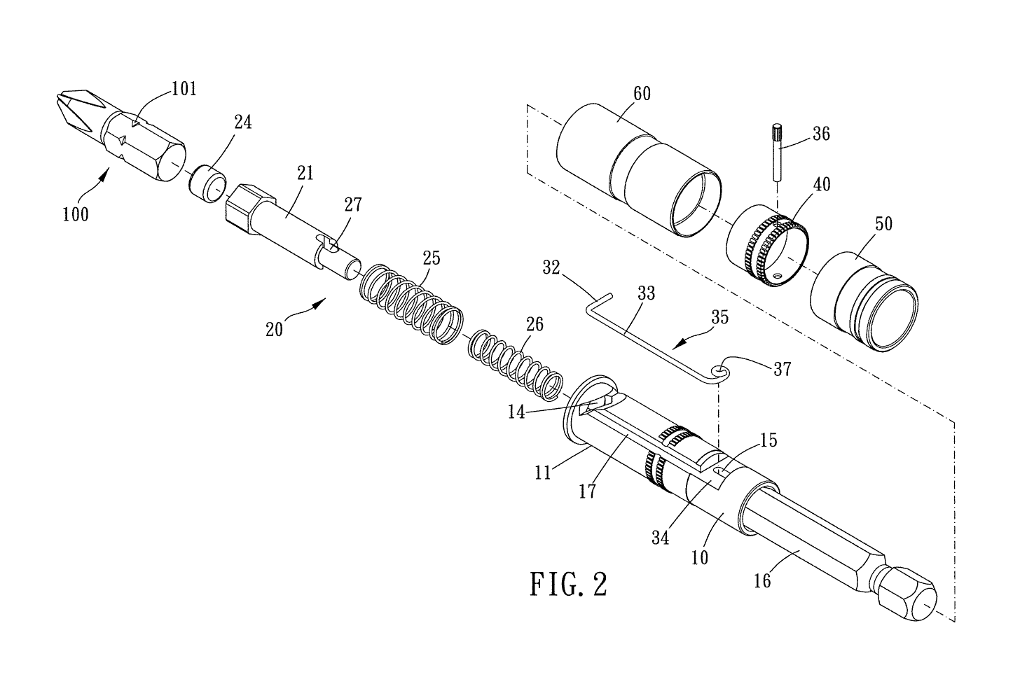

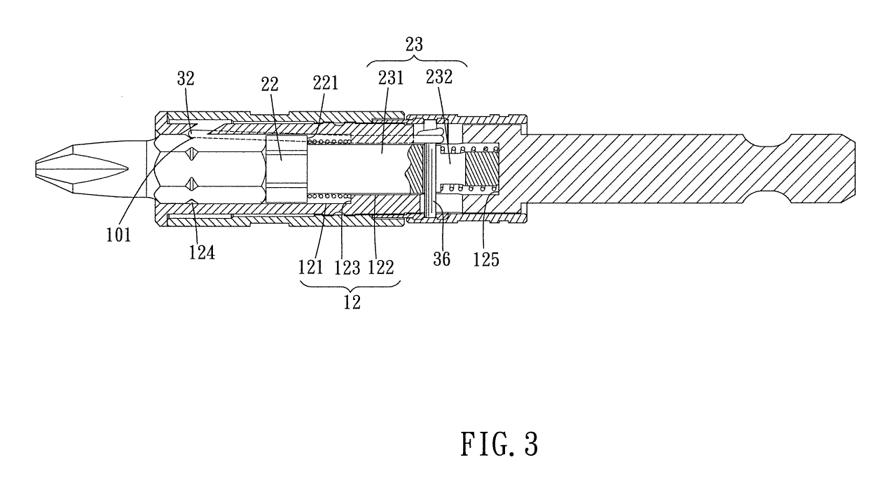

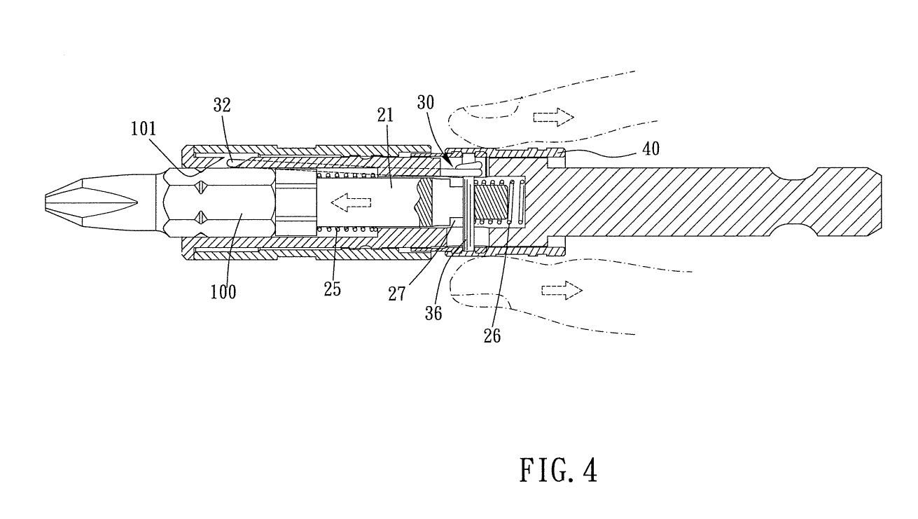

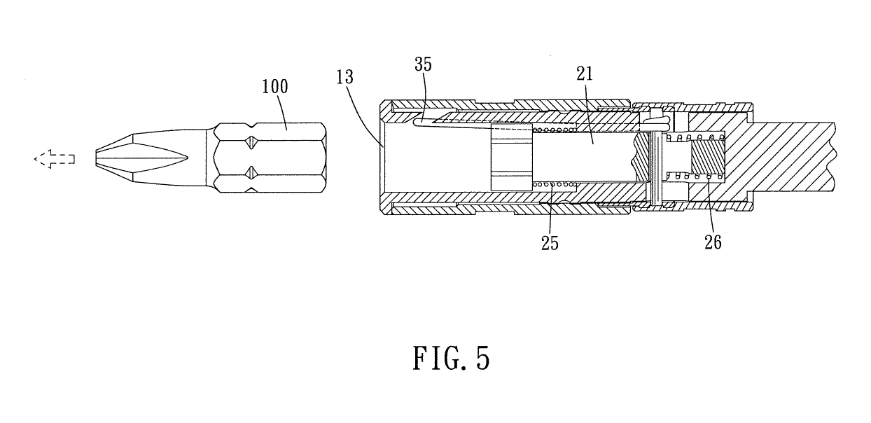

FIGS. 1-5 show a quick release connector according to a preferred embodiment of the present invention. The quick release connector 1 includes a main body 10, an elastic abutting mechanism 20 and a locking mechanism 30.

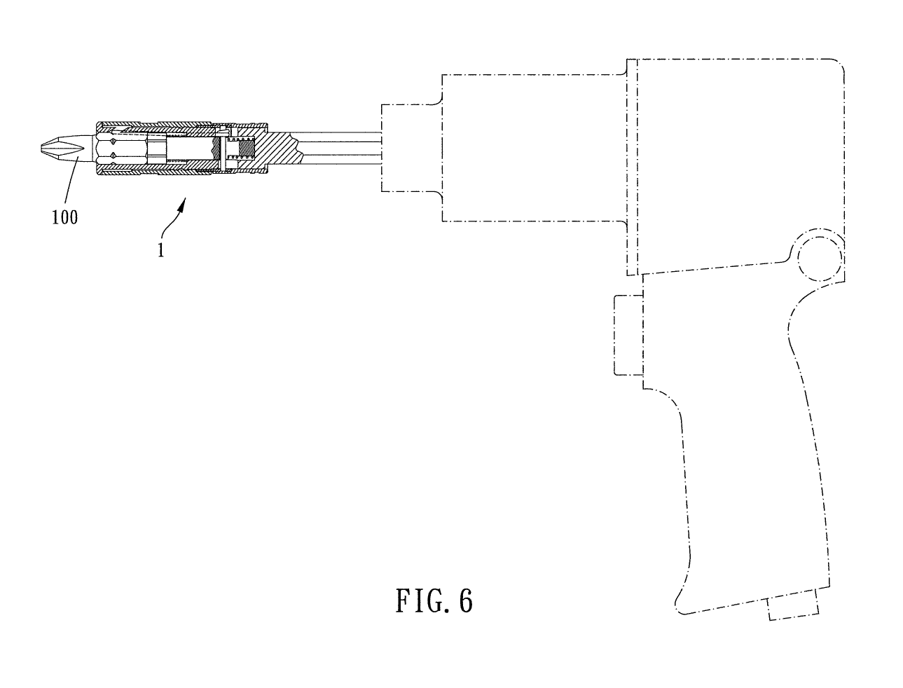

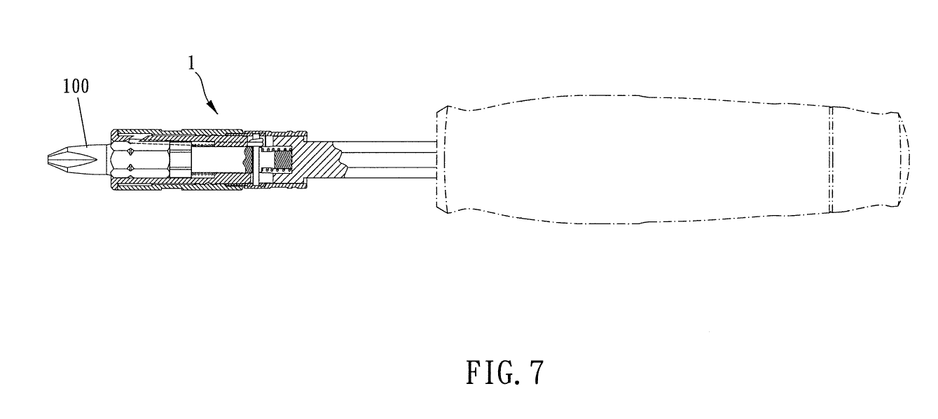

The main body includes a tubular section 11, the tubular section defines an axial direction, the tubular section includes an inner hole 12, an insertion opening 13 communicating with the inner hole, a slanted groove 14 communicating with the inner hole and a sliding groove 15 axially extending and communicating with the inner hole, and the slanted groove extends inwardly toward the insertion opening. The slanted groove may be open with a V-shaped opening on the outer face of the tubular section, or may be an enclosed slanted groove on the outer face of the tubular section). The main body preferably further includes a tool connecting end 16, and the tool connecting end is for connection with a powered too (as shown in FIG. 6), extension rod (such as elongate tool with a handle and a socket for receiving a screwdriver bit), wrench socket or the like. The tool connecting end may be integrally formed with a handle (as shown in FIG. 7). The elastic abutting mechanism is abutted within the inner hole, for urging an insert member 100 inserted into the inner hole via the insertion opening. The locking mechanism includes a pin portion 31 and a locking portion 32. The pin portion is disposed through the sliding groove and axially slidably movable together with the elastic abutting mechanism, and the locking portion is received in the slanted groove and radially projectable into the inner hole. The locking portion 32 is movable together with the pin portion 31 and the elastic abutting mechanism 20. The locking mechanism can sufficiently lock or release the insert member (such as tool bit, extension rod or the like), thus being able to quickly replace the insert member, having a simple structure and being easy to use.

Specifically, the elastic abutting mechanism includes a push rod 21 and at least one elastic member abutted between the push rod and the tubular section. The push rod includes a push head 22 and a body portion 23 connected with the push head. The inner hole includes a large-diameter section 121 and a small-diameter section 122 communicating with each other, and a shoulder 123 located between the large-diameter section and the small-diameter section. The large-diameter section communicates with the insertion opening, and the body portion is slidably inserted in the small-diameter section. Preferably the push head is provided with a magnetic member 24 for magnetically attracting the insert member, for avoid detachment of the insert member.

Specifically, the large-diameter section includes a non-circular section 124 which matches the insert member in shape. For example, the insert member is a tool bit with a hexagonal connecting end, the non-circular section is a hexagonal hole, and the push head is hexagonal and slidably disposed in the large-diameter section. The body portion includes a large-diameter portion 231 connected with the push head and a small-diameter portion 232 connected with the large-diameter portion. The push head is greater than the large-diameter portion in diameter and forms a radial flange 221 relative to the large-diameter portion. The small-diameter section includes an abutting face 125 away from the large-diameter section. A number of the at least one elastic member is two, and one said elastic member 25 is abutted between the flange of the push head and the shoulder, the other elastic member 26 is abutted between the pin portion and the abutting face. Since the locking portion is movable together with the pin portion and the elastic abutting mechanism, it requires on one elastic member (the elastic member 26) and the insert member can be sufficiently locked or released.

In this embodiment, the push rod includes an insertion groove 27 extending axially, and the pin portion is axially slidably inserted in the insertion groove. The insertion groove runs through the large-diameter portion and the small-diameter portion. The tubular section further includes a straight groove 17 which extends axially on the outer face of the tubular section and communicates with the slanted groove, the locking mechanism further includes a straight section 33 connected between the pin portion and the locking portion, and the straight section is received within the straight groove. The tubular section includes a recess 34 which is disposed on an outer face of the tubular section and communicates with the straight groove, and the sliding groove is disposed at a bottom of the recess. The locking mechanism further includes a blocking member 35 and a pin member 36, the blocking member includes the locking portion and an insertion hole 37 located within the recess, and the pin member is disposed through the insertion hole and the sliding groove and inserted into the insertion groove of the elastic abutting mechanism. In this embodiment, the blocking member is a metal wire integrally formed in one piece, the locking portion is a straight arm formed by bending the metal wire at right angle, and one end of the metal wire is coiled to form the insertion hole. The blocking member does not deform axially when operated so that it can precisely and stably lock or release the insert member.

Preferably, the quick release connector further includes a ring member 40 slidably disposed around the main body, a sleeve member 50 slidably disposed around the main body and fixedly sleeved with the ring member, and a jacket 60. The ring member is penetrated by the pin member and covers the recess, the pin member 36 is disposed through the elastic abutting mechanism, and the sleeve member blocks two ends of the pin member so as to restrict and protect the pin member. The jacket 60 is fixedly sleeved with the tubular section and disposed around a part of the locking mechanism and the ring member, whereby restricting and protecting the locking mechanism.

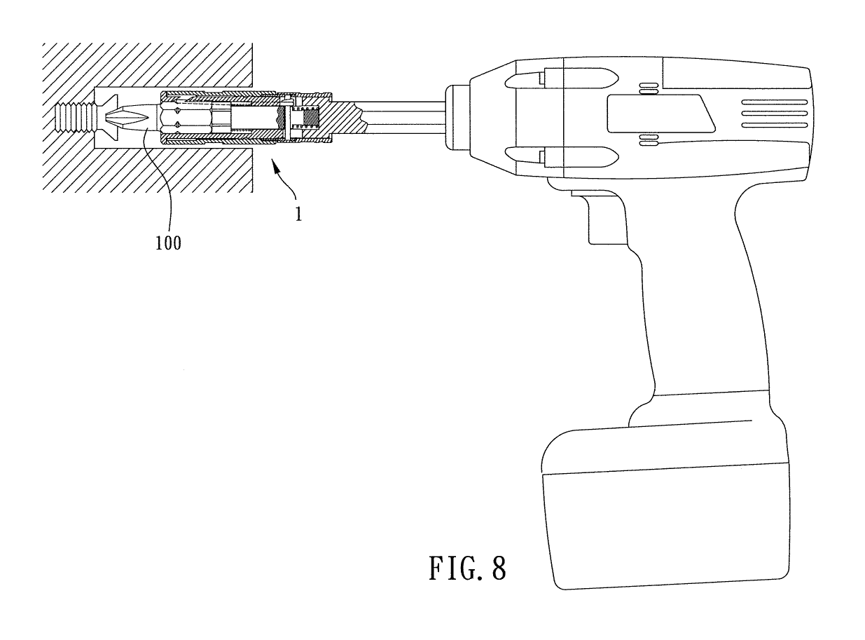

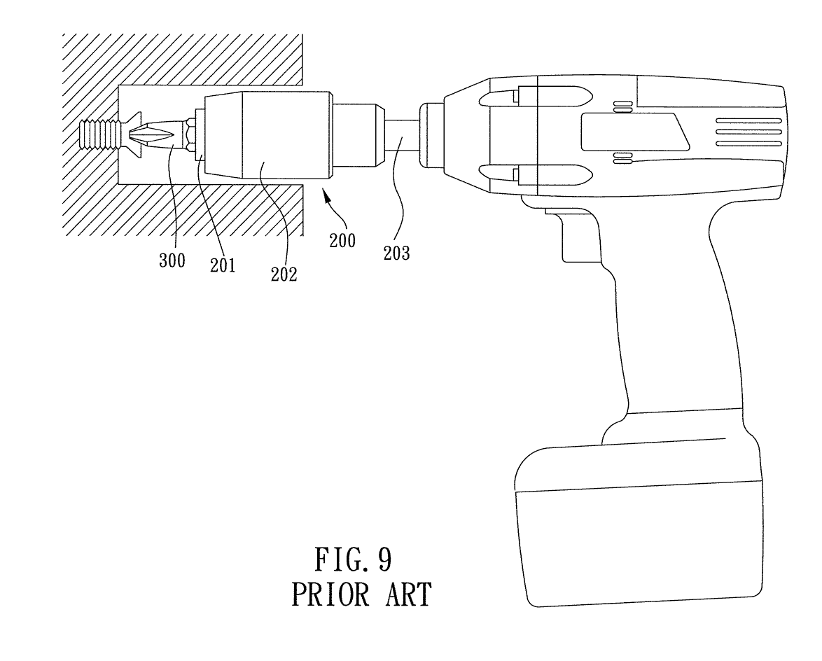

In operation, when the insert member 100 is inserted into the insertion opening 13, the insert member press the locking portion 32 of the blocking member 35 to move backward, at the same time the pin member 36 is slightly moved backward within the insertion groove 27 (the ring member may further includes a space such as annular groove corresponding radially to the pin member for axial movement of the pin member, so that it is not necessary to move the ring member backward at the same time and it is therefore easy to move the blocking member backward). When an engagement recess 101 of the insert member is aligned radially to the slanted groove 14, the elastic member 26 pushes the pin member 36 forward and drives the blocking member so that the locking portion locks the engagement recess 101 normally. As a result, the insert member can be locked automatically and is not easy to disengage; to detach the insert member, the ring member 40 is moved backward axially to in the middle portion of the insertion groove 27, the locking portion 32 disengages from the engagement recess 101 and the rear portion of the insertion groove 27 still allows the push rod to move forward relative to the pin member 36, so that the elastic member 25 pushes the push rod 21 to move forward and the insert member 100 can be jetted out automatically. As a result, the user can replace the insert member by one single hand, and it is convenient, time-saving, and helpful to work. Moreover, the ring member and parts for driving the locking mechanism are disposed at a rear end of the main body and has a small diameter, so that it can be inserted and operated in a narrow hole, and the ring member and parts for driving the locking mechanism are located outside the hole, cannot be damaged and moved to release the insert member due to impact by the inner wall of the hole during rotating, which can prevent user from being injured (as shown in FIG. 8).

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A quick release connector, including:
a main body, including a tubular section, the tubular section defining an axial direction, the tubular section including an inner hole, an insertion opening communicating with the inner hole, a slanted groove communicating with the inner hole and a sliding groove axially extending and communicating with the inner hole, the slanted groove extending inwardly toward the insertion opening;
an elastic abutting mechanism, abutted within the inner hole, for urging an insert member being inserted into the inner hole via the insertion opening;
a locking mechanism, including a pin portion and a locking portion, the pin portion disposed through the sliding groove and axially slidably movable together with the elastic abutting mechanism, the locking portion received in the slanted groove and radially projectable into the inner hole, the locking portion movable together with the pin portion and the elastic abutting mechanism.

2. The quick release connector of claim 1, wherein the elastic abutting mechanism includes a push rod and at least one elastic member abutted between the push rod and the tubular section.

3. The quick release connector of claim 2, wherein the push rod includes a push head and a body portion connected with the push head, the inner hole includes a large-diameter section and a small-diameter section communicating with each other, and a shoulder located between the large-diameter section and the small-diameter section, the large-diameter section communicates with the insertion opening, the body portion is slidably inserted in the small-diameter section, and one of the at least one elastic member is abutted between the push head and the shoulder.

4. The quick release connector of claim 3, wherein the small-diameter section includes an abutting face away from the large-diameter section, a number of the at least one elastic member is two, the other of the two elastic members is abutted between the pin portion and the abutting face.

5. The quick release connector of claim 2, wherein the push rod includes an insertion groove extending axially, and the pin portion is axially slidably inserted in the insertion groove.

6. The quick release connector of claim 1, wherein the tubular section further includes a straight groove which extends axially on an outer face of the tubular section and communicates with the slanted groove, the locking mechanism further includes a straight section connected between the pin portion and the locking portion, and the straight section is received within the straight groove.

7. The quick release connector of claim 6, wherein the tubular section further includes a recess which is disposed on the outer face of the tubular section and communicates with the straight groove, the sliding groove is disposed at a bottom of the recess, the locking mechanism further includes a blocking member and a pin member, the blocking member includes the locking portion and an insertion hole located within the recess, and the pin member is disposed through the insertion hole and the sliding groove and inserted into the elastic abutting mechanism.

8. The quick release connector of claim 7, further including a ring member slidably disposed around the main body, the ring member being penetrated by the pin member and covering the recess.

9. The quick release connector of claim 8, further including a sleeve member which is slidably disposed around the main body and fixedly sleeved with the ring member, the pin member disposed through the elastic abutting mechanism, the sleeve member blocking two ends of the pin member.

10. The quick release connector of claim 1, further including a jacket, the jacket fixedly sleeved with the tubular section and disposed around a part of the locking mechanism.

11. The quick release connector of claim 2, further including a jacket, the jacket fixedly sleeved with the tubular section and disposed around a part of the locking mechanism.

12. The quick release connector of claim 3, further including a jacket, the jacket fixedly sleeved with the tubular section and disposed around a part of the locking mechanism.

13. The quick release connector of claim 4, further including a jacket, the jacket fixedly sleeved with the tubular section and disposed around a part of the locking mechanism.

14. The quick release connector of claim 5, further including a jacket, the jacket fixedly sleeved with the tubular section and disposed around a part of the locking mechanism.

15. The quick release connector of claim 6, further including a jacket, the jacket fixedly sleeved with the tubular section and disposed around a part of the locking mechanism.

16. The quick release connector of claim 7, further including a jacket, the jacket fixedly sleeved with the tubular section and disposed around a part of the locking mechanism.

17. The quick release connector of claim 8, further including a jacket, the jacket fixedly sleeved with the tubular section and disposed around a part of the locking mechanism.

18. The quick release connector of claim 9, further including a jacket, the jacket fixedly sleeved with the tubular section and disposed around a part of the locking mechanism.
